(19) United States
(12) Patent Application Publication
(10) Pub. No.: US 2005/0132398 A1
(43) Pub. Date: Jun. 16, 2005

(54) System and method for individualizing TV programming choices

(76) Inventors: David Baran, Atherton, CA (US); Paul Baran, Atherton, CA (US)

Correspondence Address: DAVID NEWMAN CHRTD, P.O. BOX 956, INDIAN HEAD, MD, 20640, US

(21) Appl. No.: 10/796,909

(22) Filed: Mar. 10, 2004

Related U.S. Application Data
(60) Provisional application No. 60/529,147, filed on Dec. 15, 2003.

(51) Int. Cl. H04N 7/16; H04N 7/025; H04N 7/10

(52) U.S. Cl. 725/28; 725/34; 725/35

(57) ABSTRACT

Improving the TV watching experience by the use of digital video time shifting and micro program guides per program to match an interest profile filter for each viewer. This is coupled with a payment mechanism to allow each individual the capability of watching TV programs in a manner consistent with their individual interests and values, and simultaneously protecting the economic rights of the content provider. To date, the cable industry increases revenues by offering additional programming to their customers. This invention teaches that major additional revenue can also be created by the omission of undesired content.

### RELATED PROVISIONAL PATENT APPLICATION

This patent stems from a U.S. provisional patent application Ser. No. 60/529,147, and filing date of Dec. 15, 2003, entitled INDIVIDUALIZING TV PROGRAMMING CHOICES, by inventors, DAVID BARAN and PAUL BARAN. The benefit of the earlier filing date of the provisional patent application is claimed for common subject matter.

### BACKGROUND OF THE INVENTION

This invention relates to increasing the value of the TV viewer's time by the creating, transmitting and utilizing TV programs customized to individual tastes and preferences in general, and more particularly to increasing the value to the content provider by payment for the elimination of unwanted program content.

### DESCRIPTION OF THE RELEVANT ART

Some content control is provided by the existing V-Chip system for entire programs. Many programs, however, have composite content such as a news program. Parents may judge some program elements as inappropriate for their children, such as coverage of the sexual exploits of politicians or entertainment figures, or even coverage of violence such as terrorist activities. By providing a more granular mechanism for viewer protection, parents can leave the TV on to watch the news with less risk of children viewing something that they should not view.

The United States is a nation that tolerates a broad range of social values in a “live and let live” culture. Unnecessary friction, however, exists among those with different values with respect to mass media delivered content. Violence, obscenity, nudity perfectly acceptable by many, is strongly disliked by others. A common reluctance exists for allowing children to watch such programs. Far less objection to such content delivery via media exists where a separate purchase is required, such as books and magazines. A greater tolerance to controversial content when access is restricted and requires separate payment such as in the case of satellite and cable. When still further additional fees are required for access such as HBO or the Playboy channel, even less objection is observed even though the material would be totally unacceptable if delivered over the “over-the-air” broadcast channel. The reason is that the programming is visible only to those who have specifically paid for access, and “in-your-face” broad exposure is avoided.

The loudest political objections are heard when the “free” over-the-air mass media distribution channel openly transmit content with personal values that markedly differ from those of some of its viewers. “Hollywood” and its distribution channel have been attacked by Congress, in response to transmitted fare deemed to be excessive in violence, and sex. There is a strong sense of revulsion to such programming by the more religiously conservative portions of the country, and complaints are sometimes directed toward the advertisers. In addition, much television programming is exported from the United States to other countries. Having the sensitive parts of the programming tagged makes it easier for broadcasters in other countries to adapt the content for their local viewers.

### SUMMARY OF THE INVENTION

A general object of the invention is to improve the TV watching experience by using digital video time shifting and micro program guides per program to match an interest profile filter for each viewer.

Another object of the invention is a payment mechanism which allows each individual the capability of watching TV programs in a manner consistent with their individual interests and values, and simultaneously protecting the economic rights of the content provider. To date, the cable industry increases revenues by offering additional programming to their customers.

A further object of the invention is to create additional revenue from the omission of undesired content.

The present invention, as broadly described herein, includes a process for allowing a viewer at a TV, display, to bypass undesired segments of a TV program. The process comprises the steps of storing one or more TV programs containing a first class of metadata. The first class of metadata includes a start location and a stop location of potentially undesired segments. The steps include retrieving one of the TV programs for display, and defining, with a second class of metadata, unwanted segments specific to the user of the TV display. The steps include matching the first class of metadata with the second class of metadata. In response to matching the first class of metadata with the second class of metadata, the steps include removing undesired segments from the TV program.

The process may further comprise the step of reimbursing program suppliers for a financial loss occasioned by removed material.

An alternative embodiment of the present invention includes an apparatus for removing unwanted TV material. The apparatus includes a personal video recorder (PVR) network server, a specific TV program for delivery to a specific TV display, and a processor.

The PVR network server is located at a distribution system head end. The PVR network server stores multiple TV programs with one or more TV programs containing TV metadata, the first class of metadata. The specific TV program has stored metadata, the second class of metadata, defining unwanted program segments. The processor compares the TV metadata with the stored metadata. In response to the comparison, the processor removes undesired program segments including the unwanted TV material.

The apparatus may further include bookkeeping means, for charging a viewer for costs, including reimbursing a program supplier for a financial loss from removing the undesired program segments.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention.

FIG. 1A illustrates 6 MHz frequency space for one analog channel;

FIG. 1B shows 6 MHz of frequency space, which is the equivalent of 10 analog channels encoded using digital modulation;

FIG. 2 illustrates analog transmission and digital transmission;

FIG. 3A shows type/length value describing an attribute of the underlying program;

FIG. 3B shows type/length value describing an attribute of the underlying program;

FIG. 4A shows a flow diagram illustrating payment from the broadcaster-distributor to the content producer;

FIG. 4B shows a alternate flow diagram illustrating money flow;

FIG. 4C illustrates how commercial removal is more efficient in terms of providing additional free time to consumers by eliminating commercials;

FIG. 5 is a system block diagram;

FIG. 6 is a an example of how particular attributes could be expressed in set 1 and set 2;

FIG. 7 is a flow diagram illustrating how the attributes are utilized to alter the presentation of content of FIG. 6;

FIG. 8 is a flow diagram illustrating how the attributes are utilized to alter the presentation of content of FIG. 6;

FIG. 9 illustrates a specific implementation for metadata transmission is to encode it in MPEG-2 frames using an alternate program ID;

FIG. 10 is a flow diagram illustrating how TLV changes are processed by the controller; and

FIG. 11 is a flow diagram illustrating how forward skip requests are processed.

### DETAILED DESCRIPTION OF THE PREFERRED EMBODIMENTS

Reference now is made in detail to the present preferred embodiments of the invention, examples of which are illustrated in the accompanying drawings, wherein like reference numerals indicate like elements throughout the several views.

The invention disclosed in this patent is a novel implementation for creating a win-win outcome for 1) the content provider, 2) the channel provider, and 3) most importantly, for improving the TV viewer's watching experience and not, for example, require wasting time watching unwanted commercials.

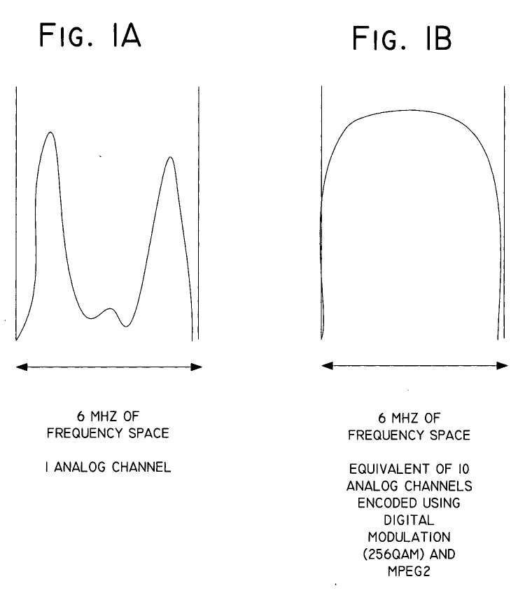

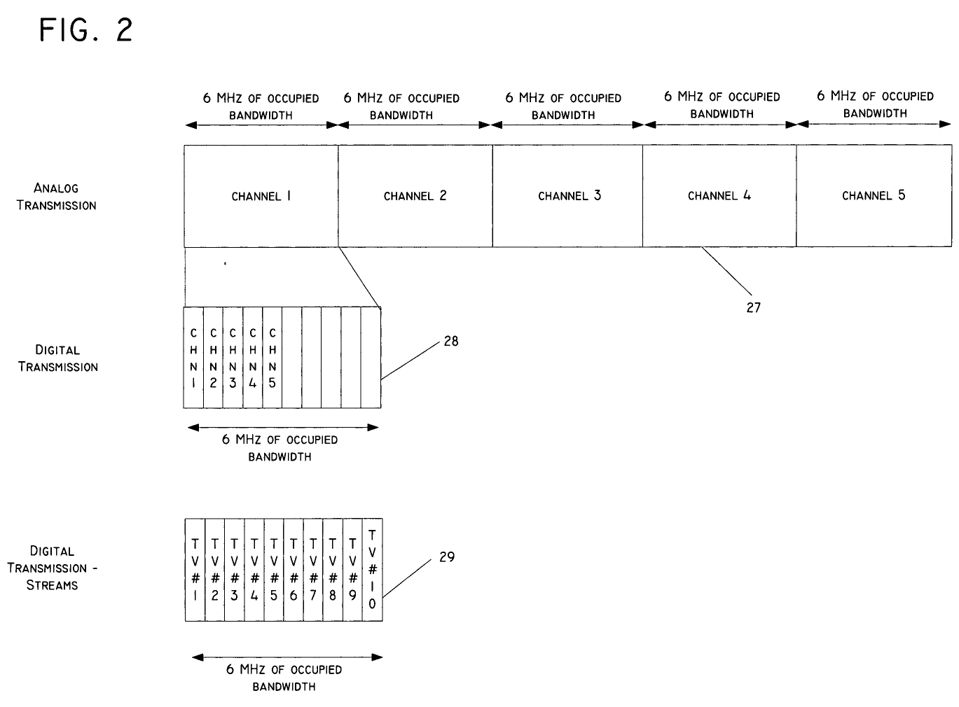

The world of TV rapidly is moving to digital transmission and processing because digital transmission and processing more efficiently uses bandwidth. Available bandwidth presently is the scarcest commodity available to a cable operator. The revenue potential to cable operators is limited by the number of service offerings the cable operator can pack into their limited spectrum bandwidth available on their cable plants, as shown in FIGS. 1A and 1B. In addition to increased transport efficiency, cable operators' move to an all-digital model allows cable operators to offer attractive new higher value functionality to consumers as well as reducing cable signal theft which amounts to 11% of those receiving cable TV on a national level.

A typical cable operator in the United States has frequency space to deliver approximately 126 analog channels. U.S. analog requires six megahertz of dedicated bandwidth per channel, as shown in FIG. 1A. Cable systems which transmit television digitally, using QAM modulation, can pack up to ten analog channels into the same six megahertz space, as illustrated in FIG. 1B. Digital transmission of television effectively can increase the number of possible channels tenfold, to 1,260 or more using more effecting compressions standards such as MPEG-4 or Windows Media 9.

Using current technology, supporting 1,260 channels is not economically feasible for operators. Because traditional televisions sets have receivers only capable of decoding analog television, operators wishing to deliver television using digital modulation must provide a set top box to convert the digital signals back to analog for reception by each TV set. Today, these set top boxes generally cost several hundred dollars per unit. The cost has limited their utilization to premium services where a small number of users' set top boxes are required and the consumers are paying enough to warrant deployment of the expensive hardware.

In stream-based television, individual dynamically dedicated subchannels within a digital channel are used to deliver television to individual TV receivers. This effectively gives each TV set its own channel to the cable head end and allows close tailoring of the content delivered to the TV to match the particular consumer's wishes.

By leveraging the two-way cable TV plant, operators can provide networked personal video recording capabilities at a fraction of the cost of individually deployed Personal Video Recorder (PVR) when providing individually directed digitally multiplexed stream-based television instead of the traditional broadcast analog television 27, as shown in FIG. 2. As rapidly increasing sales of hard-disk based personal video recorders have shown, customers want the ability to quickly pause, rewind, and fast forward through content. Current PVR implementations have a number of shortcomings, including reliability, scalability, cost, and noise.

The following assumes that TV signals are processed in digital form 28 but generally, but not always, terminate in analog form. The following discussion also assumes that the digital TV signals are stored in a time-buffer memory. A time-buffer memory supports time-shifting so that each TV viewer has their own choice of time of receipt of the delayed delivered video stream. The following discussion further assumes that there is adequate time delay, buffering, memory to strip out unwanted program portions, e.g., undesirable programming, unwanted commercials, etc., and not overrun the time buffer memory.

The following also assumes that the content in the new form of TV can be adopted incrementally so that the technology may be applied to some TV channels but not others. This allows conventional TV delivery to continue without change, simultaneously with the adoption of this invention. Of course, the approach described is applicable even if all channels are digital 28, 29, as shown in FIG. 2.

Today, about 308 TV channels of different programming are available. Most TV channels are highly specialized. A wide choice of programming is thus available, similar to magazines. Given the large number of magazines, each magazine aims at a specific audience. The potential reader is free to buy or not buy a magazine.

Similarly, with the choice of TV programming, the viewer also is free to watch or not watch a program, just as the content provider is willing or not willing to have viewers being so selective.

With the move to all-digital transmission, existing TV cable can carry over 1,000 channels of TV. The arrangement described in the preferred embodiment thus provides an almost infinite number of different channels that can be simultaneously delivered to any TV set. This increased competition for the viewer's attention by the wide choice of content helps provide the incentives to allow the viewer a fuller degree of freedom on what they want to watch.

The present invention creates a new social compromise, by allowing each TV viewer to define undesired material and to suppress the undesired material. The suppressed undesirable material could eliminate the social stress that exists today. To many, the definition of undesired material, programming, includes advertising. Today the sound on commercials is often muted out using the remote control. The personal video recorder (PVR) shifts time total removal of commercials, using the fast forward button. A major factor leading to the rapid adoption of high priced PVRs is in the PVRs capability of stripping out commercials.

The present invention recognizes the advertiser's right to maintain the coupling between programming and advertising if the National model of “Free” television is to remain viable. Content developers collect money from advertisers and transfer their programs to the delivery system, e.g., over the air broadcasters, satellite and cable systems.

TABLE 1
Cable Advertising
(Numbers are in billions of dollars)

| | |
|---|---|
| Parents to cable programming | $9.5 |
| Payments to local cable system | $3.3 |
| Cable advertising market size: | $12.8 |

In the cable market alone, as shown in Table 1, USD $12.8 billion is raised through the sale of commercials to support content development. Kagan's Economics of Basic Cable Networks, 2003. Numbers presented here are shown net of the commission paid by the cable networks to advertising agencies. Recent estimates have said that advertisement skipping will lead to a reduction of revenue to advertisers by about 20% by 2006. To maintain the same level of free content, providing an alternate revenue source is critical for content providers. The system outlined herein accomplishes this by allowing consumers to skip unwanted advertising if they are willing to compensate the content provider by a similar amount. This provides the benefit of allowing content to continue to be delivered “for free” to those customers willing to view commercials, while allowing other consumers to opt out of an advertising-supported model.

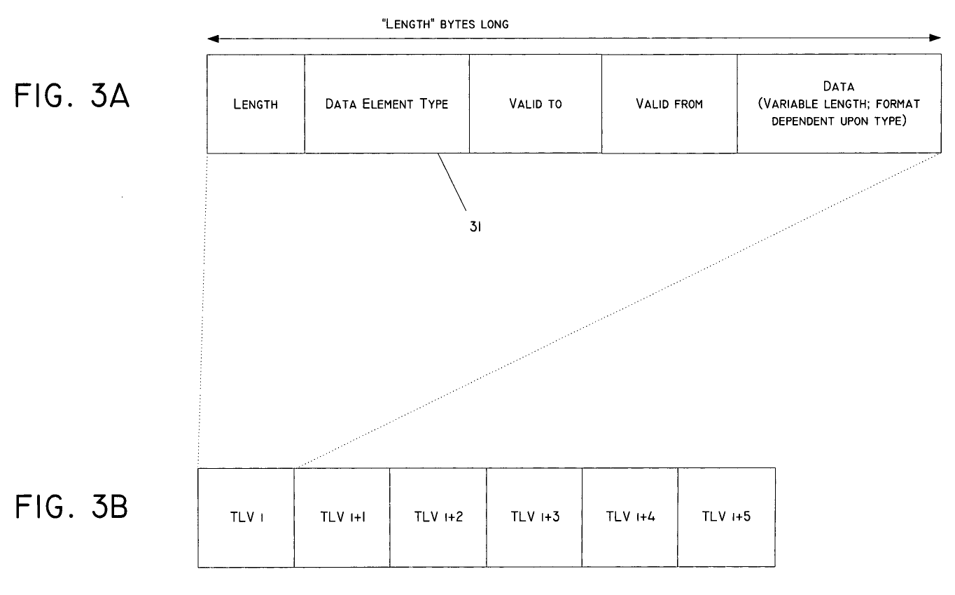

To implement these new capabilities, control information called “metadata” is needed. FIGS. 3A and 3B show the metadata 31, as used by the present invention, which have elements known as type/length values (TLV). The metadata include a first class of metadata and a second class of metadata. The first class of metadata, which is embedded in TV programming, includes a start location and a stop location of potentially undesired segments. The second class of metadata defines unwanted segments specific to the user of said TV display.

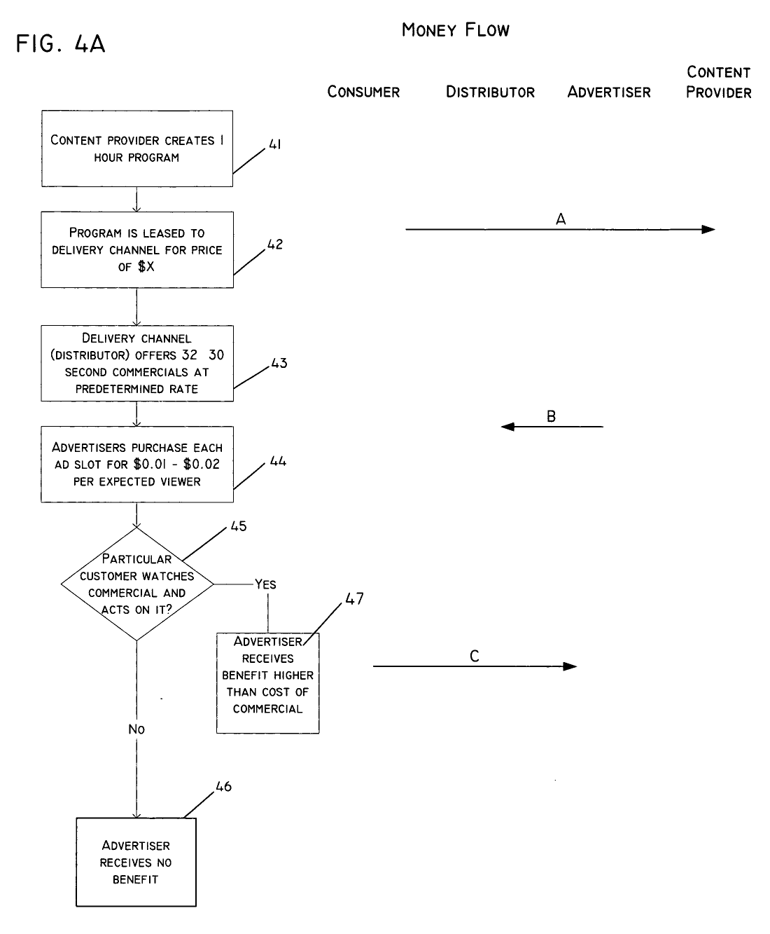

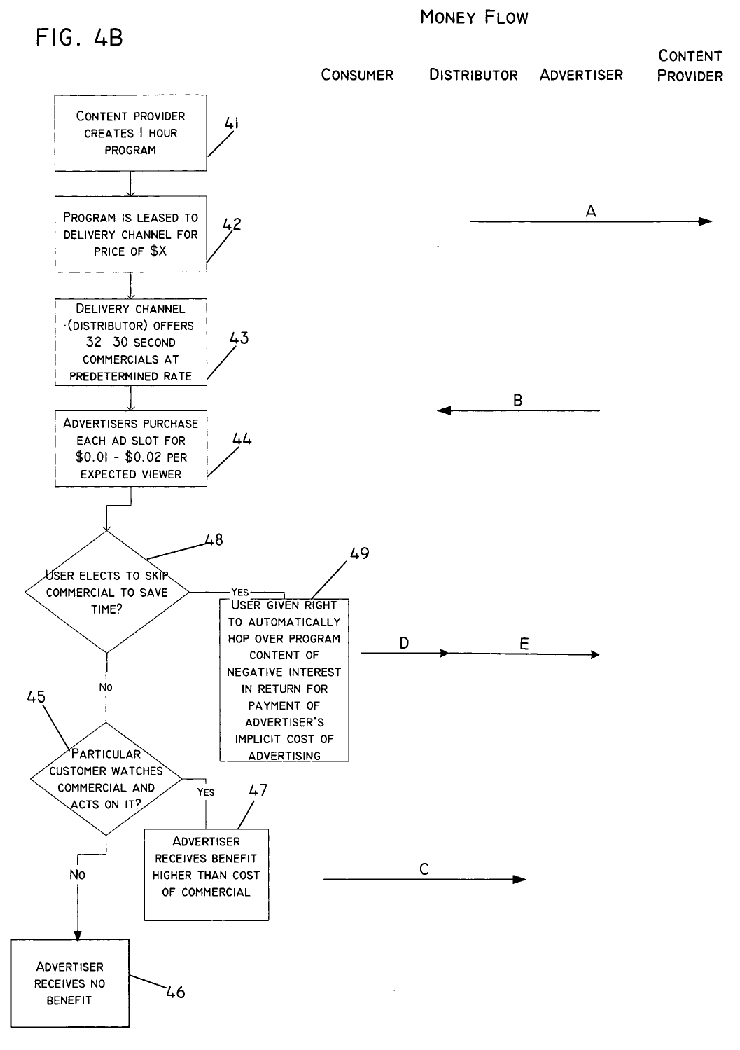

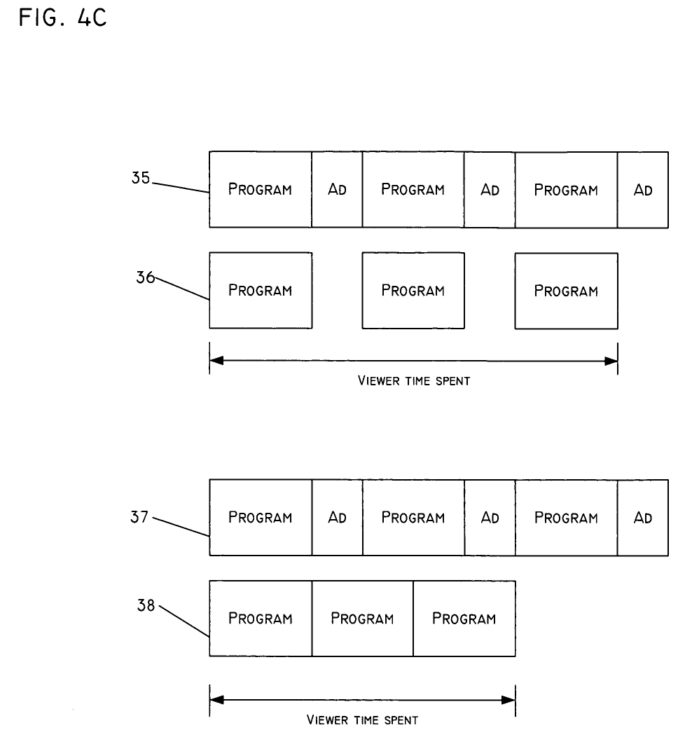

FIG. 4A illustrates the current model, for the present flow of funds involved in the maintenance of the free delivery of television. In FIG. 4A, by way of example, a content provider creates 41 a one hour program. The program is leased 42 to delivery channel for price of $X. The delivery channel, or distributor, offers 43, for example, about thirty-two (32) separate, thirty second commercials at a predetermined rate. The advertisers purchase 44 each advertisement slot for $0.01-$0.02 per expected viewer. If a particular customer watched the commercial and acted 45 on it, then the advertiser receives 47 the benefit, which hopefully is higher than cost of the commercial. If the particular customer watched the commercial and did not act 45 on it, then the advertiser does not receive 46 the financial benefit of the commercial.

In real time operation, commercial skipping usually is limited to muting the sound or looking away from the TV set. Commercials are often not watched unless they are particularly interesting to the viewer. In the FIG. 4A, “A” represents the payment from the broadcaster-distributor to the content producer in exchange for the rights to distribute the particular program. “B” is the sum of the payments from advertisers to the distributor. The amount of the sum of the payments stream is determined based on the demographic reach and rating of the content in question, i.e., a higher rate for a popular show such as “E.R.” and a lower rate for content with less reach such as “Golden Retriever Week in Review.” Standard economics indicate that “B”, revenue, will be larger than “A”, cost of content, if all parties are rational actors in a functional economic system.

“C” is an implicit value derived by the advertiser when a consumer, target of the advertising, responds to the call to action of the advertisement. This may be the profit from the sale of goods or services or it can also be a change in overall consumer perception that is favorable to advertising. “C” is the marginal return to the advertiser on the marginal cost of the advertiser reaching a viewer. Given the traditional microeconomic rules and rational actors, the sum of implicit “C”, marginal revenue, values to the advertiser will always exceed “B”, marginal cost, of the advertising. Were this not the case, then the advertiser would cease to advertise as the return on the advertising investment would be negative. Under the current model, the advertiser incurs a loss of “B” when their message is not delivered, ignored, or rejected by a potential consumer. With the rise of PVRs, commercials increasingly likely will be skipped without any impact on the consumer. Skipping of commercials increases the overall loss to the advertiser. Research indicates that up to 80% of commercials are skipped by those with PVRs, and the population of customer PVRs is projected to continue to increase.

To avoid the increased loss to advertisers, present invention model is shown in FIG. 4B. FIG. 4B assumes a time shifted environment in which viewers who value their time to be on the order of a dollar or more per hour and are willing to pay for the privilege of being able to skip 48 commercials automatically by a compensatory payment 49 to the advertisers for the commercials not watched. In this model, the customer pays “D” to the distributor, a portion of which is used to compensate the advertiser for “B”. The portion of the revenue from the consumer who skipped 48 the commercial is “E”, which can be more, less, or the same amount as “D” depending on the commercial arrangements negotiated between the parties. In the most likely case, “D” will be larger than “E”, and “E” will be equal to “B”.

Under this model, a content stream is produced which includes elements which viewers want to see, for example, the program itself, combined with elements that the viewer did not specifically request, for example, commercials. Advertisers pay to obtain either the right to present their offer or to present the opportunity to view their offer, depending upon which legal theory prevails in the current court cases. A major legal issue arrives when a device or service provider removes the advertising from the content stream before it is presented to the ultimate recipient. When this occurs, the viewer is receiving the value of the program without viewing the advertising which is unfair to the advertisers who sponsored the content.

One of the novel elements of the present invention is that it provides the necessary mechanism to fully compensate advertisers for the loss when pieces of content are deleted.

In the coming time shifted era, time spent in waiting for commercials to be over can be recaptured. FIG. 4C illustrates how commercial removal is more efficient in terms of providing additional free time to consumers by eliminating commercials. A commercial, or ad, between a program 35 can be removed 36. The removed ad from between programs 37 allows the programs to be transmitted 38, with more time available, possibly for an additional program.

Prior art methods such as reading or talking during commercials result in wasted time which cannot effectively be reclaimed for other purposes because the wasted time occurs in a large number of short intervals, i.e., death by a thousand paper cuts. Hence, the ability to legally remove commercials has far, far greater value in the time-shifted world than today's real time broadcast delivery arrangement.

The major issue in the case of the commercials is that there is a potential financial loss to the advertiser that would require a compensatory payment equal to or greater than the price of the “eyeball” price paid for the commercial space. An analysis of this cost for the entire cable industry for 2002 was estimated and found to be approximately 13.3 cents per hour. As the average viewer spent about 4.2 hours watching TV each day the daily average cost would be on the order of about $0.56 per day. If computed on a total household basis, where about 6.5 hours of TV per day are watched, this comes to about $0.86 per day. On the other hand, major network programs reaching very large audiences carry a premium price on the order of $0.02 for a 30 second commercial. And as there are on average about 32 such commercial slots per hour, this cost could be as high as $0.64 per hour.

The key point is that at a modest price paid by those who do not wish to watch programs interrupted by commercials can more than compensate the advertisers for their “lost eyeballs.” There is enough potential profit in the additional fee greater than their cost of providing that commercial that the advertiser benefits in several ways. The commercial is not watched by those with no interest, and instead the money that would have gone to deliver this ad the money can be returned to them even with a profit. This leaves those that want to watch an ad either interested or believe that their time is worth less than $1 per hour.

This financial arrangement would be voluntary. Only those willing to pay would have commercials removed. And only those TV programs acceptable to this arrangement would do so. Otherwise the status quo as we know it today can be maintained for those that prefer not to change in the way TV is delivered to the home.

Advertisers would probably not be willing to let their commercials be stripped, nor will the studios willingly allow their content to be modified. But as a practical measure, the PVR allows a degree of semi-manual commercial stripping by use of the fast forward button. If nothing were done by advertisers, then increased commercial stripping is highly likely, and without compensation. The present invention seeks to make it worth the while of the advertiser and content provider to willingly go along with this new freedom by the viewer with remuneration used as a financial compensatory mechanism for content providers agreeable to this arrangement. Of course the final decision as to what content is handled in this manner is strictly up to each content provider. If a content provider did not wish their content to be filtered in any manner, then that is their right not to do so.

This invention also supports options between the binary choices. For example, advertisements have value, and sometimes great value to those specifically interested in the item for potential purpose. Those that choose to watch some advertisements and not others could be charged at a lower rate, and the advertiser charged more for these particular users.

There are many alternative arrangements possible, and it should be understood that this invention is not restricted to the specific combinations of payment described herein as a number of other modifications of the basic concept are feasible.

Program Content Selection

Program content often is described by the term “metadata”. Metadata, as illustrated in FIGS. 3A and 3B, refers to such items as the content of the program, the start time, technical information about the program's content, and bookmarks describing the time to each transition or scene change. The use of metadata is old art, and there are standards evolving to handle metadata on a universal basis. There is an extensive body of patent literature covering the subject of parsing content and applying bookmarks to each of the items in programs. What is new is how the metadata elements are structured in this present invention and how these metadata elements are used.

The metadata occupies very little data space and can be sent separately or encoded within the basic communications channel.

The metadata prepared for this application does not have to be done in real time, as all the program material is assumed to be delayed in transmission sufficiently to insure that when sections of a program are truncated, the end of the truncated program does not slip into the real time period, or during the time that the metadata is being prepared.

The adding of metadata, sometimes called “bagging and tagging” lends itself to artificial intelligence approaches. But for the descriptive purpose of this application it is sufficient to note that the process can be done totally manually, even be done in a contract employee's house as long as the broadcast program is available.

There are two distinctly different types of metadata of interest. The first type of metadata is that related to the program itself. This is a one-time operation and could be used throughout the country as this same program is repeated. The second type of metadata is local in the choice of advertising and even its time insertion can change from system to system. The requirements for developing these two types of data are different.

The first type of metadata that is program related can be done by the content provider or by the distribution system. The first type of metadata includes a one time matter for each program and does not change over time. The first type of metadata is a combination of descriptors and a time mark. Time is referenced to a start flag found at the beginning of each program. Timing of the raw program can use the always present time stamping of the digital stream such as used in MPEG-2 and MPEG-4.

A human operator aided with a computer viewing the program and keeping track of each frame relative to the timing mark can allow a user to define the start and stop of each segment of each program. A computer program stores the program, and displays the program to a human operator, and allows fast forwarding and reversing. The operator's keyboard can be arranged so that a single keystroke or a few keystrokes would correspond to each parameter to be recorded. These parameters are generally boundary values. For example, the beginning and end of each spurt of profanity could be marked. The profanity marked metadata could, if the individual users desires mute the sound of their TV set, if that were what they chose. Where the viewer does not care, the sound would go through unattenuated. That describes the first type of metadata.

The second class of metadata is distribution related. The start and end of each commercial would be of this type.

A number of efforts have been described in the patent literature directed toward spotting the beginning and end of advertisements automatically. The information is sometimes based on the observation that 1) there is a black frame a short period of silence before the beginning and end of each ad, 2) ads tend to run about modulo 30 seconds, with most being 30 second adds and 3) the sound level of the commercials tend to be about 3 dB louder than the program sound level, but not always and 4) commercials often appear at the beginning and end of the program, consistently, but less so in the middle of the program.

Probably the most controversial metadata in the mind of the advertisers is the start and stop times of commercials and their suppression by the viewer. Historically the content providers intentionally avoided any computer detectable signal that would allow the automatic removal of commercials.

The issue of whether a subscriber can remove ads without the permission of the content provider is a legal issue that is yet to be resolved. A subscriber certainly can do if the content provider approved, and were compensated for their loss. But whether approved or not, commercial stripping is occurring today via the PVR and may be expected to occur in the future regardless of whatever legal outcome occurs. In fact this may be the main reason for purchase of PVRs. With commercials up to over 20 minutes per hour for late night news, and averaging 16 to 17 minutes per hour over the day, the desire to fast forward over the commercials is widespread and very strong.

If the program producer would flag these changes, as well as the content metadata, would be most convenient. This is not unreasonable to expect as content providers that agree to go along with this service will receive additional compensation from the viewer.

Since the metadata can be carried separately the metadata permits its use in any of a number of locations such as networked PVRs at cable headends, set top boxes, local PVRs and even in the TV set itself.

In this invention, the metadata includes elements known as type/length values (TLV). Each type/length value describes an attribute of the underlying program, and consists of the following data elements, as shown in FIG. 3A: Length of the entire type and value in bytes; Attribute type or data element type; Validity period—“from” and “to”; Attribute values, one or more bytes; the format of this data is dependent upon which type it is, i.e., different types have different data requirements.

One or more TLVs are grouped together as shown in FIG. 3B to encode all necessary attributes to describe the program.

It is expected that more descriptive attributes will be added as deployment of the technology progresses.

The metadata elements can be classified into two categories. The first set of metadata, Set 1, is descriptive of the program's content. The second set of metadata, Set 2, defines the viewer's personal preferences, and in most cases is unique to the viewers of a single TV set. This information comes from a database which can either be local to the subscriber terminal unit (STU) or can be transmitted from the headend.

The first set of metadata elements can be added to the program at the time of program initiation or may be added at a later date. This can be done manually, but techniques are being developed to automate part of the process. This process is regarded as prior art and not described herein. The first set of metadata would start with the identification of the program and define program breaks and identification of the commercials and their start and stop timing.

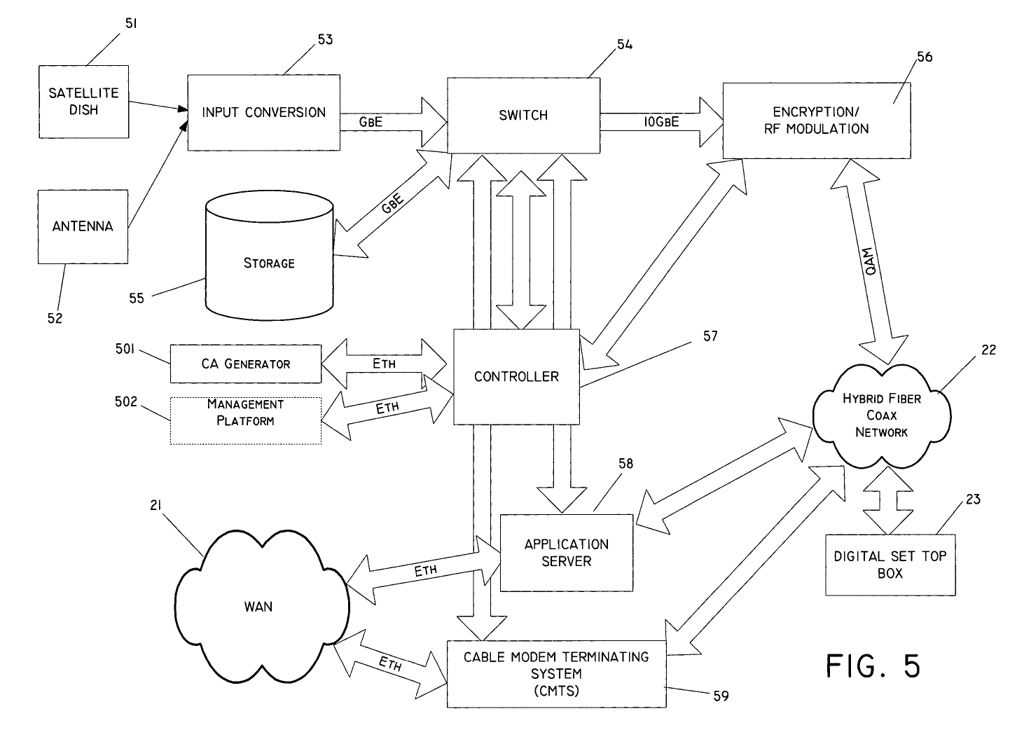

FIG. 5 shows a system block diagram. Programming or content may be received from a satellite through satellite dish 51, and converted to appropriate frequency by input converter 53. Programming or content alternatively make arrive from an antenna and converted by input converter 53. Programming or content from input converter 53 may be in digital form, and sent over a high speed data link, such as Gigabit Ethernet, to switch 54. Switch 54 routes data to any of encryptor and RF modulator 56 and to or from controller 57 and to or from storage 55. Controller 57 routes data between switch 54 and legacy devices such as a conditional access key generator 501 and a management platform 502 and the encryptor and RF modulator 56. CMTS 59 exchanges data from HFC network 22 with the switch 54, which can in turn pass data to controller 57, application server 58, encryptor and RF modulator 56, wide area network 21 such as the Internet, and the storage unit 55. Data may be sent over hybrid fiber and/or coax cable network 22 to a user, set top box 23. The set top box 23 is connected to a television, as is well known in the art.

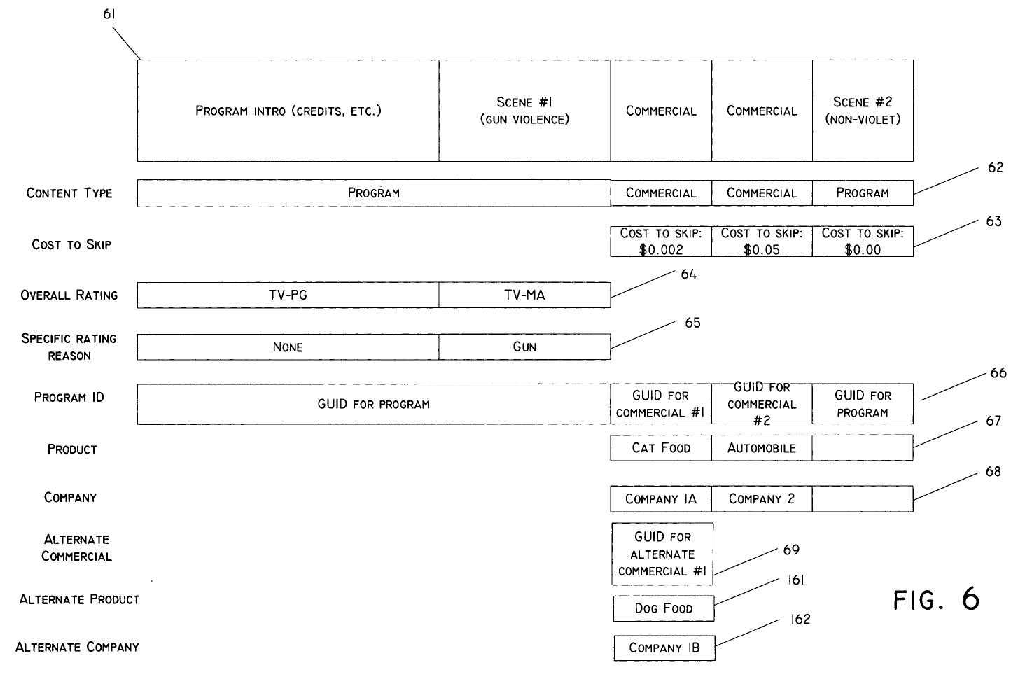

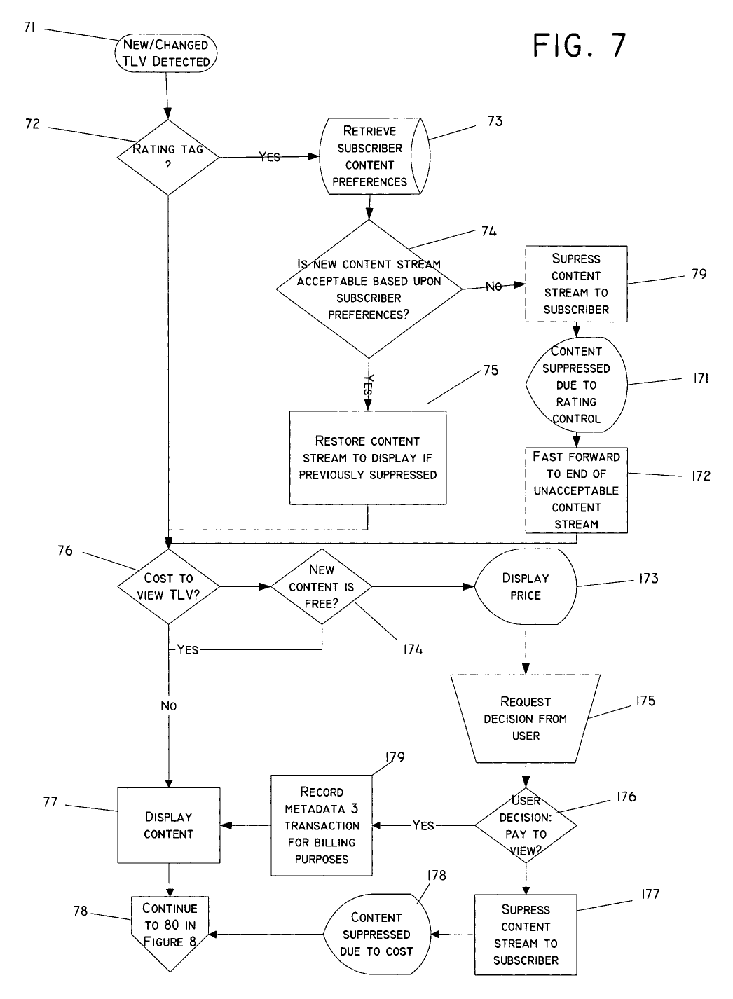

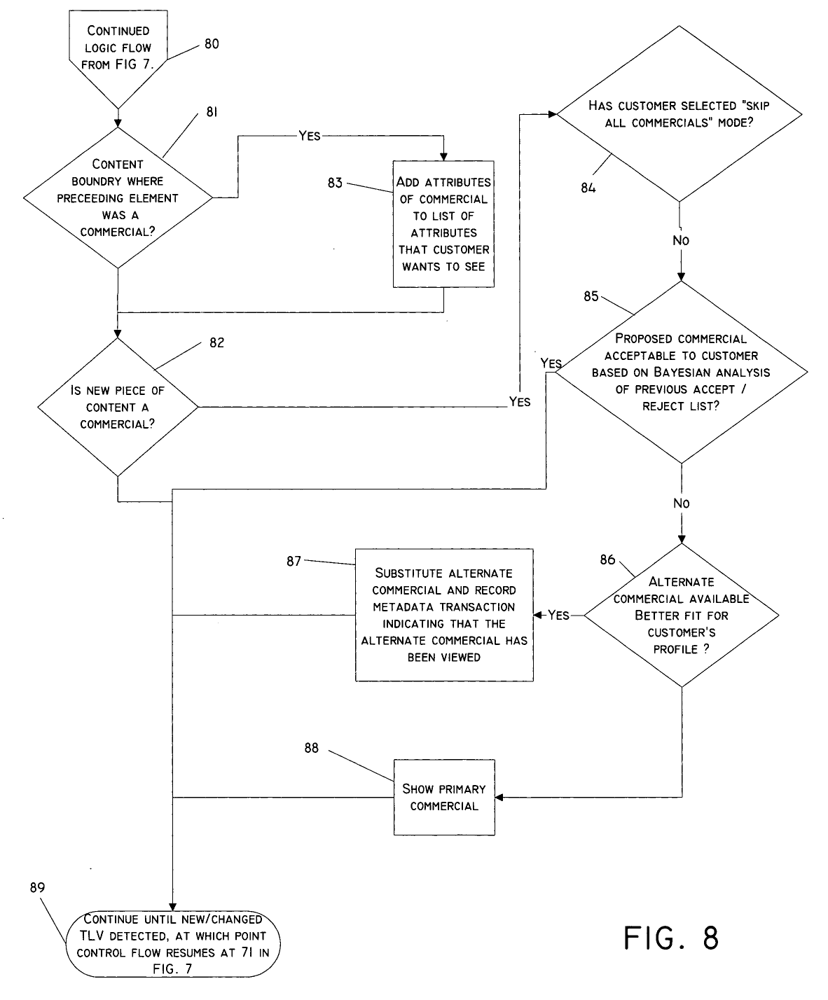

Set 1 and Set 2 metadata elements are evaluated in combination by the head end equipment, including any of controller 57, encryptor and RF modulator 56, application server 58, and CMTS 59, in FIG. 5, to determine how the content should be processed. FIG. 6 provides an example of how particular attributes could be expressed in set 1 and set 2, and FIGS. 7 and 8 describe how the attributes 61 are utilized to alter the presentation of content.

In FIG. 7, a new or changed TLV is detected 71. The method determines if the detected TLV has a rating tag 72. If no, then the method proceeds to determine cost 76 to view TLV. If yes, then the method retrieves 73 subscriber content preferences from a database. The method then determines if the new content stream is acceptable 74 based upon subscriber preferences. If no, then the method restores 75 content stream to display if previously supressed, and proceeds to cost 76 to view TLV. If no, then the method supresses 79 content stream to subscriber. The content is supressed 171 due to rating control. The method then fast forwards 172 to end of unacceptable content stream, and proceeds to cost 76 to view TLV.

If there were no cost 76 to view TLV, then the method displays 77 the content. If there is a cost 76 to view the TLV, then the method determines if the new content is free 174. If yes, the method proceeds to display 77 the content. If the content were not free 174, then the method displays 173 and requests 175 a decision whether to pay or not to pay, from the user. If the user, at the subscriber, decides 176 to not pay to view the content, then the content is suppressed 177 to the subscriber. The content is suppressed 178 due to cost, and the method proceeds to 80 in FIG. 8. If the user at the subscriber decided to pay 176 to view, then the method records 179 metadata transaction for billing purposes. The content is displayed 77, and the method proceeds to 80 in FIG. 8. While FIG. 7 describes the process for handling advertising compensation for commercial skipping, FIG. 8 describes the process used to manage the learning process for which commercials are most appropriate for a particular viewer. This will be discussed below.

The content type 62, in FIG. 6, is used to determine what is the regular program, payload, and what is sponsor provided material.

The cost to skip 63, in FIG. 6, provides the financial cost of the sponsor to deliver their commercial message; from a fairness perspective, this is the amount of the sponsor's loss if their commercial message is suppressed.

The overall rating 64 of the underlying program, in FIG. 6, is designed to follow the industry's television rating rules.

Specific rating reasons 65 for a particular content rating can be included, in FIG. 6. This allows particular pieces of potentially offensive content to be differentiated allowing a finer granularity of what is presented—among some groups of television viewers, nudity is OK but gun violence is not.

Program ID 66, in FIG. 6, is a guaranteed unique identifier (GUID) which allows precise identification of the transmitted content. The GUID must be assigned so that it uniquely identifies a particular piece of content for intellectual property purposes. Content providers will assign these identifiers to their programs before transmission.

For commercials, a controlled keyword vocabulary will be used to identify one or more attributes of the commercial 67, 68, 69, 161, 162, in FIG. 6. This allows the system to learn which advertisements are not of interest to the consumer based on attributes. When a particular commercial is rejected by a customer, the keywords of the rejected advertisement are added to a list of attributes of unwanted commercials. When a commercial is allowed to play to completion, the attributes are added to a list of commercial attributes that are possibly desirable by the particular consumer. Over time, these two lists and common Bayesian analysis, prior art, can be used by the application server 58, in FIG. 5, to provide a self-learning system that selects the commercials that are most valuable to a consumer.

As deployment of this model advances, it becomes likely that there will be more than one advertisement for each potential commercial space. For example, a customer who doesn't own a cat has no use for cat food, but the same sponsor may be willing to pay to run a dog food commercial in the same time slot. The process for managing the alternate commercials is shown in FIG. 8. For an input commercial 80, a content boundary is determined if a preceding element was a commercial 81. If yes, then add 83 attributes of the commercial to list of attributes that customer wants to see. The new piece of content is tested to determine 82 if the new piece of content is a commercial. If not, then the content continues to be displayed. If the new piece of content is a commercial, then the method determines if the customer selected skip 84 all commercial mode. If yes, then the method skips the commercial. If not, then the method determines if new piece of content or commercial is acceptable 85 to the customer based on Bayesian analysis of previous acceptance/rejection list. If yes, then the method allows the new content or commercial to be viewed. If no, then the method determines if there is an alternative commercial available that better fits customer's profile 86. If no, then the method shows 88 the primary commercial. If yes, then the method substitutes the alternative commercial and record 87 metadata transaction indicating that the alternative commercial has been viewed.

Using attributes 66, 67, 68, 69, 161, 162 in FIG. 6, the controller 57, application server 58, CMTS 59 in FIG. 5, can select the most appropriate commercial given the user's observed behavior of accepting or rejecting particular commercials and the most effective commercial can be selected using the GUID for the commercial 66, in 6, and the commercial can be digitally inserted into the particular viewer's video stream by the video storage and switching units 54 in FIG. 5. An alternative method would be declarative, where the viewer interactively selects the type and amount of commercials that are acceptable using the two way capability of the system.

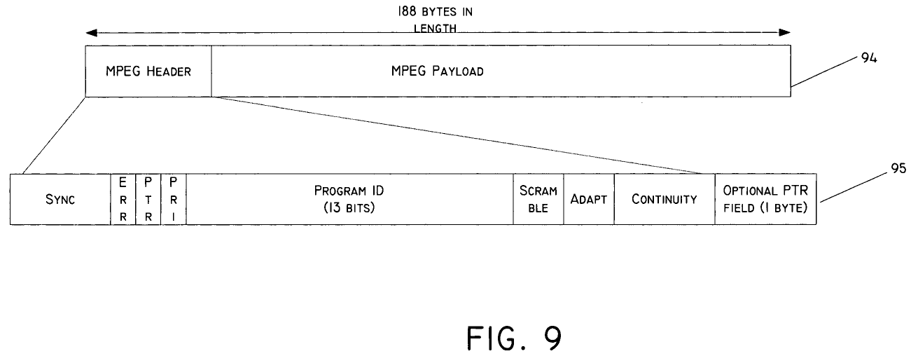

One specific implementation for metadata transmission is to encode the metadata in MPEG-2 frames 94 using an alternate program ID, as shown in FIG. 9. The program IDs (PID) currently are used to differentiate between multiple channels carried in the same MPEG header 95, digital channel. The PID of 0x1FFE is used by the Data Over Cable System Interface Specification (DOCSIS) and the underlying message in the remainder of the MPEG cell can be encoded as a vendor specific DOCSIS Media Access and Control message. This ensures that it does not interfere with any existing equipment for MPEG frame processing.

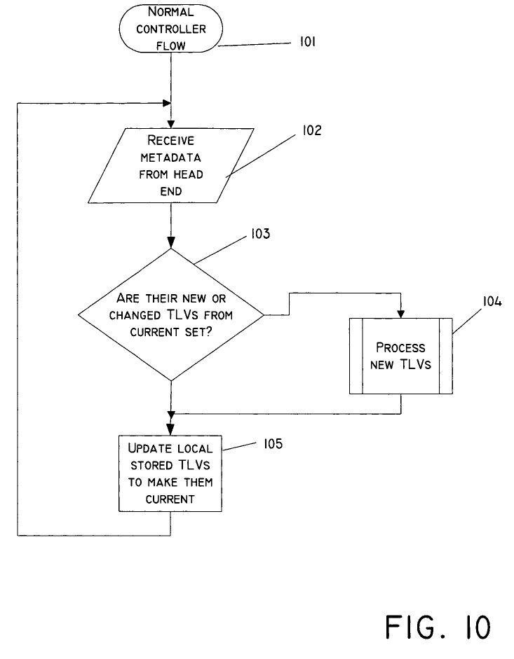

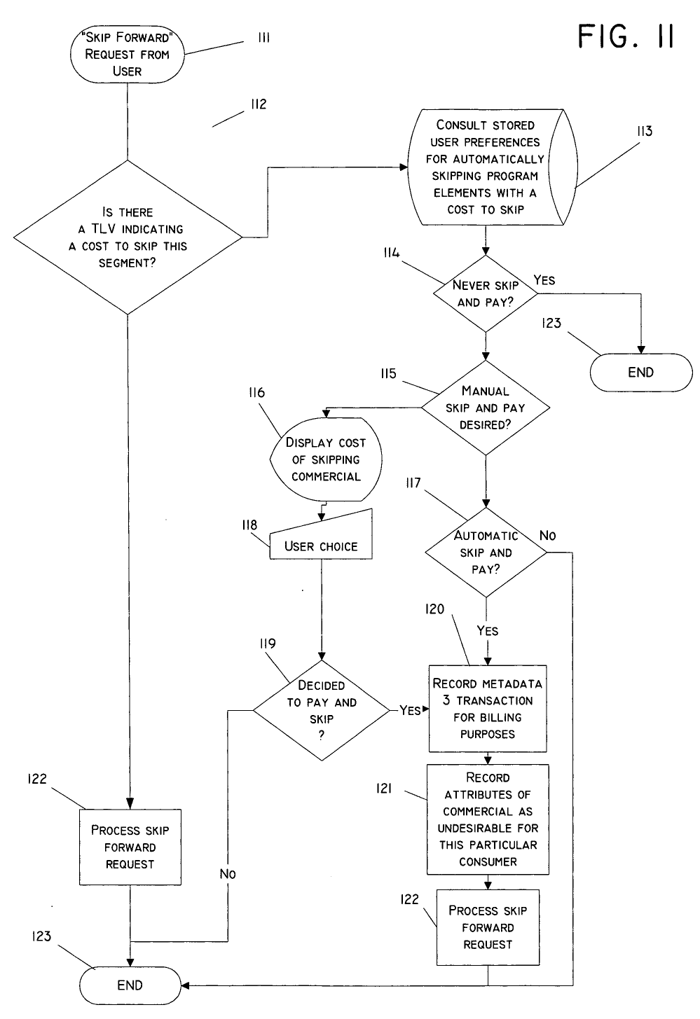

FIG. 10 shows how TLV changes are processed by the controller. From normal controller flow 101, the method receives 102 metadata from the head end. The method then determines if new or changed TLVs from the current set 103. If yes, then the method precesses 104 the new TLV. Then the method updates 105 stored TLVs to make them current. To detect that a change in one or more of the TLVs has occurred, a checksum calculation using a prior art mechanism such as MD5 con be used. As long as the checksum remains the same, the TLVs have not changed. Should a calculated checksum across a current TLV set differ from the checksum calculated across prior TLVs, then one or more TLVs has been changed. Since the number of TLVs in use at any particular time is finite, one approach would be to use as an index into a data structure containing the current value of each TLV element. By examining each TLV in the current message against the stored values of the TLV from previous messages, one can readily determine which TLV has changed and how it has changed by comparing the current and previous values for the TLV.

FIG. 11 shows how forward skip requests are processed. A skip forward request 111 is received from the user. The objective is to ensure that the advertiser is fairly compensated, and there are several alternative approaches that can be used. The method determines if there is a saying that there is a cost 112 to skip within the segment. If no, then the method processes 122 the skip forward request, and ends 123. If there is a cost to skip, then the method consults 113 stored user preferences for automatically skipping program elements with a cost to skip. The method then determines if the user never 114 skip and pays. This could be called the cheapskate model. If yes, the user is a cheapskate, then the method ends. If no, the user is willing to pay to skip the commercials, then the method determines if the user wants to know how much the commercial costs before deciding to skip the commercial, i.e., a conditional cheapskate. If yes, then the method determines the cost 116 of skipping the commercial and presents this amount to the user. The user has a choice 118 to pay. The user then can decide to pay and skip 119 the commercial, and then the method ends 123. If the user does not decide to pay to skip, then the forward skip request is discarded and the commercial is presented to the user. If the user has decided to always skip commercials regardless of the individual cost 117, i.e. spendthrift, or has decided to pay to skip in the conditional cheapskate model 119, then a billing transaction is prepared and recorded 120. The system then records the attributes of the commercial as being undesirable for the particular consumer 121 and proceeds to skip forward in the video stream 122 by the length of the commercial.

If the user does not elect manually skip and pay 115, then the method determines if automatic skip and pay 117. If no, then the method ends. If yes, then the method records metadata transaction for billing purposes. Similarly, if the user decided to pay and skip 119, then the method records metadata transaction for billing purposes. The method then records 121 attributes of commercial as undesirable for this particular customer method processes 122 the skip forward request, and ends 123.

While the preferred embodiment of this invention uses the RetroVue System, described in U.S. patent application Ser. No. 20030200548 by Baran et al, the invention is general and can be implemented on personal video recorders as well. And while two-way cable is described in the preferred appropriately connected through input 53 embodiment, satellites 51 and other communications media 52 could be used. While MPEG-2 is described as the compression algorithm used, other formats such as MPEG-4 or WM-9 may be used as well. In FIG. 5, the return path from the hybrid filter network is terminated at the cable head end by a Cable Modem Terminating System (CMTS) 59. The key requirement is that there is some mechanism for the subscriber to be able to convey information back to the application controller 57 and application server 58, see FIG. 5. In a one-way cable plants or satellite broadcast systems 51, this can be done via wireless communication systems, cellular 52, PCS, SMS, power line carrier, Internet, or by a phone line.

In the RetroVue System a high quality full-time digital channel is dynamically assigned to each separate TV set to a cable head end. The RetroVue system is in the class of Networked Personal Video Recorders (NPVRs). It differs from the in-house Tivo or ReplayTV personal video recorder (PVR) as its storage and processing is done on a shared basis at the cable head end and is able to store up to about 150 simultaneously incoming programs. By recording all programs and storing them for many hours, the RetroVue System does not require the viewer to know which program he or she wishes to record in advance. Further the NPVR obviates the need for rotating memory devices in the house, and this reduces capital and maintenance costs. However in the present invention, in house PVRs can be used as well as networked PVRs, as will be later shown.

This allows each user to view any TV program at a time of the own choice. When moving to an all-digital, or near-all-digital cable system the number of individual cable channels can be increased by a factor of about ten as described earlier. A 120 channel analog cable system can now carry 1200 separate higher quality digital TV channels.

The modern cable plant passing almost the entire population of the US has been upgraded to support two way transmissions, needed for data modems—a highly lucrative service offered by the cable operators. There is a limitation when cable is used for the common shared reverse path. The upstream noise increases as the number of houses sharing the cable increases. A preferred design limit is to have only about 600 houses connect to a separate fiber feeder to the cable head end. Thus if each cluster of 600 houses is regarded as an independent entity, there will be 1200 channels that are dynamically shared among 600 houses allowing each TV set its own dynamically assigned virtual channel to the cable head end. Therefore in the preferred embodiment of this invention there is more than adequate capability to support each user individually.

It will be appreciated that the concepts presented here are basic in nature intended to teach general principles and can be implemented in many different ways falling within the spirit of the invention.

It will be apparent to those skilled in the art that various modifications can be made to the system and method for individualizing TV programming choices of the instant invention without departing from the scope or spirit of the invention, and it is intended that the present invention cover modifications and variations of the system and method for individualizing TV programming choices provided they come within the scope of the appended claims and their equivalents.

1. A process for allowing a viewer at a TV display to bypass undesired segments of a TV program comprising the steps of:
a. storing one or more TV programs containing a first class of metadata including a start location and a stop location of potentially undesired segments;
b. retrieving one of the TV programs for display;
c. defining, with a second class of metadata, unwanted segments specific to the user of said TV display,
d. matching the first class of metadata with the second class of metadata; and
e. removing, responsive to matching the first class of metadata with the second class of metadata, undesired segments from the TV program.

2. The process as set forth in claim 1, further comprising the step of time shifting two or more programs, to fill time space resulting from removing undesired segments from the TV program.

3. The process as set for in claim 1, further comprising the step of financial reimbursing program suppliers for a financial loss occasioned by removed material.

4. The process as set forth in claim 3, further comprising the step of time shifting two or more programs, to fill time space resulting from removing undesired segments from the TV program.

5. An apparatus for removing unwanted TV material comprising:
a shared personal video recorder (PVR) network server at a distribution system head end, said PVR network server for storing multiple TV programs with one or more TV programs containing TV metadata;
a specific program delivered to a specific TV display, with the specific program having stored metadata defining unwanted program segments; and
a processor for comparing the TV metadata with the stored metadata by removing undesired program segments including the unwanted TV material.

6. The apparatus set forth in claim 5, further comprising means time shifting two or more programs, to fill time space resulting from removing undesired segments from the TV program.

7. The apparatus as set forth in claim 5 further including bookkeeping means, for charging a viewer for costs, including reimbursing a program supplier for a financial loss from removing the undesired program segments.

8. The apparatus as set forth in claim 7, further comprising means time shifting two or more programs, to fill time space resulting from removing undesired segments from the TV program.

9. An apparatus for removing unwanted TV material comprising:
personal video recorder (PVR) server means, located at a distribution system head end, for storing multiple TV programs with one or more such programs containing TV metadata; a specific program delivered to a specific TV display, with the specific program having stored metadata defining unwanted program segments; and
processor means for comparing the TV metadata with the stored metadata by removing undesired program segments including the unwanted TV material.

10. The apparatus as set forth in claim 9, further comprising means time shifting two or more programs, to fill time space resulting from removing undesired segments from the TV program.

11. The apparatus as set forth in claim 9 further including a bookkeeping means, for charging costs to a viewer, including reimbursing a program supplier for a financial loss from removing the undesired program segments.

12. The apparatus as set forth in claim 11, further comprising means time shifting two or more programs, to fill time space resulting from removing undesired segments from the TV program.
